(19) United States
(12) Patent Application Publication
(10) Pub. No.: US 2026/0209523 A1
(43) Pub. Date: Jul. 23, 2026

(54) WATER-REPELLENT COATING AND ARTICLE

(71) Applicant: Mitsubishi Electric Corporation, Tokyo (JP)

(72) Inventors: Ayumi MINAMIDE, Tokyo (JP); Yasuhiro YOSHIDA, Tokyo (JP)

(73) Assignee: Mitsubishi Electric Corporation, Tokyo (JP)

(21) Appl. No.: 19/145,250

(22) PCT Filed: Jan. 12, 2023
(86) PCT No.: PCT/JP2023/000576

§ 371 Date: Jul. 2, 2025

(51) Int. Cl. C09D 5/00; B05D 5/08; B05D 7/00; C08K 3/36; C08K 7/18; C08K 9/06; C08K 9/12; C09D 7/40; C09D 7/62; C09D 127/18; C09D 175/04; C09D 183/04

(52) U.S. Cl. CPC C09D 5/00; B05D 5/083; B05D 7/52; C08K 3/36; C08K 7/18; C08K 9/06; C08K 9/12; C09D 7/62; C09D 7/67; C09D 7/69; C09D 7/70; C09D 127/18; C09D 175/04; C09D 183/04; B05D 2503/00; B05D 2506/10; B05D 2518/12; B05D 2601/22; C08K 2201/005; C08K 2201/011; C08K 2201/014

(57) ABSTRACT

A water-repellent coating contains spherical particles, inorganic fine particles having an average particle diameter less than an average particle diameter of the spherical particles, inorganic nanoparticles forming fine irregularities on a surface, a water-repellent resin having water repellency, and an oil.

### TECHNICAL FIELD

The present disclosure relates to a water-repellent coating and an article having water repellency.

### BACKGROUND ART

A water-repellent coating having water repellency and an article having a water-repellent coating formed thereon are conventionally known. A water-repellent surface having fine irregularities exhibits super water repellency. Such water-repellent surfaces have an effect of reducing adhesion of water, ice, or snow. By application of such a coating which forms a water-repellent surface to outdoor devices, malfunction arising from adhesion of water, ice, or snow can be reduced. Here, the malfunction refers to, for example, a decrease in signal level in antennas or other appliances, a short circuit in insulation equipment or other apparatuses, or fixation of a movable part. Furthermore, the water-repellent coating can also save time and effort required for operations including removal of ice and snow adhering thereto.

Patent Literature 1 discloses, for example, a coating containing a fluororesin powder or an inorganic fine powder whose surface has been treated to be hydrophobic, a silicone resin binder, and a silicone oil. Patent Literature 2 discloses a water-repellent coating containing silicone and a water-repellent fluororesin. Patent Literature 3 discloses a water-repellent coating having excellent wear resistance that includes an undercoat layer containing spherical particles and a base resin, and an overcoat layer containing inorganic nanoparticles and a water-repellent resin.

### CITATION LIST

### Patent Literature

Patent Literature 1: Japanese Unexamined Patent Application Publication No. 2000-26844
Patent Literature 2: Japanese Unexamined Patent Application Publication No. 10-
Patent Literature 3: Japanese Patent No. 6180698

### SUMMARY OF INVENTION

### Technical Problem

However, the super water repellency of the water-repellent coating disclosed in Patent Literature 1 is due to the silicone oil covering irregularities of the inorganic fine powder. The silicone oil is therefore present on the surface, which is likely to cause dirt, resulting in a decrease in water repellency. As to the coating disclosed in Patent Literature 2, the super water repellency readily decreases due to friction, depending on the characteristics of the components. Regarding the coating disclosed in Patent Literature 3, the decrease in performance due to friction is reduced, but its super water repellency may decrease locally due to, for example, a strong stimulus such as collision with an object, a lightning strike, or electric discharge that occurs in the case where, for example, the coating is applied to insulation equipment. Although the local decrease in the super water repellency does not greatly affect, for example, the reduction in snow accretion, the portion with decreased super water repellency may become a starting point from which deterioration spreads further, and creeping discharge or other problems may be likely to occur.

The present disclosure has been made to solve the above problems, and an object thereof is to provide a water-repellent coating and an article that are not likely to deteriorate due to friction, and maintain initial performance even when super water repellency decreases locally.

### Solution to Problem

A water-repellent coating according to an embodiment of the present disclosure contains spherical particles, inorganic fine particles having an average particle diameter less than an average particle diameter of the spherical particles, inorganic nanoparticles forming fine irregularities on a surface, a water-repellent resin having water repellency, and an oil.

### Advantageous Effects of Invention

According to the embodiment of the present disclosure, the water-repellent coating contains an oil. Due to permeation of the oil, initial performance is maintained even when super water repellency decreases locally.

### BRIEF DESCRIPTION OF DRAWINGS

FIG. 1 is a sectional view illustrating a water-repellent coating according to a comparative example.

FIG. 2 is a sectional view illustrating a water-repellent coating according to Embodiment 1.

FIG. 3 is a sectional view illustrating a water-repellent coating according to Embodiment 2.

FIG. 4 is a sectional view illustrating a water-repellent coating according to Embodiment 3.

### DESCRIPTION OF EMBODIMENTS

Water-repellent coatings and articles according to embodiments of the present disclosure will be described below with reference to the drawings. Note that the present disclosure is not limited by the embodiments described below. In addition, the dimensional relationship between the components in the drawings may differ from that of actual ones. Furthermore, although directional terms are used as appropriate in the following description to facilitate understanding of the present disclosure, such terms are for the purpose of describing the present disclosure but not for limiting the present disclosure. Examples of the directional terms include “above”, “below”, “right”, “left”, “front”, “back”, and other terms.

### Embodiment 1

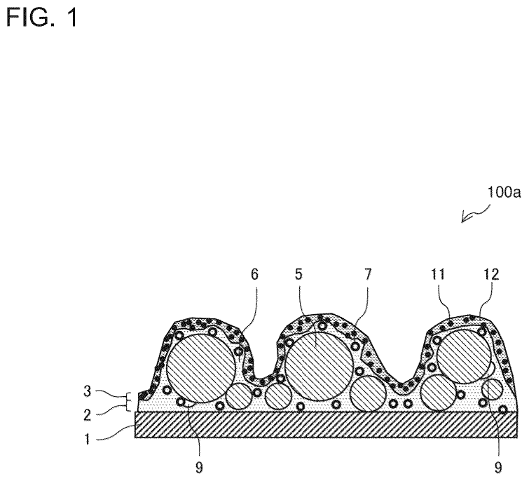

FIG. 1 is a sectional view illustrating a water-repellent coating 100a according to a comparative example. Next, the water-repellent coating 100a according to the comparative example will be described. To facilitate understanding of the description of a water-repellent coating 100 of Embodiment 1, the water-repellent coating 100a according to the comparative example will be described first. As illustrated in FIG. 1, the water-repellent coating 100a according to the comparative example includes an undercoat layer 2 and an overcoat layer 3 formed to cover the undercoat layer 2. The undercoat layer 2 contains spherical particles 5, a base resin 6, and inorganic fine particles 7. The overcoat layer 3 contains inorganic nanoparticles 11 and a water-repellent resin 12. Due to the spherical particles 5 of the undercoat layer 2, irregularities are formed in the undercoat layer 2. Due to the irregularities of the undercoat layer 2, the overcoat layer 3 also has irregularities on the surface. The water-repellent coating 100a exhibits super water repellency due to the surface having the overcoat layer 3. Even when subjected to friction, the water-repellent coating 100a can maintain its super water repellency while the overcoat layer 3 is worn at the portions above the spherical particles 5, because most of the overcoat layer 3 is left in the recessed portions. In a situation where the undercoat layer 2 is broken, for example, by abrasion with a sharp-edged article, however, a hydrophilic substance contained in a substrate 1 or in the coating or a hydrophilic substance coming from the outside may be exposed to the outside, and water droplets may readily adhere thereto.

In addition, minute voids 9 may be formed between the spherical particles 5 and the base resin 6 or between the inorganic fine particles 7 and the base resin 6 of the undercoat layer 2. Even after the minute voids 9 are formed, the overcoat layer 3 formed on the upper surface of the undercoat layer 2 allows the water-repellent coating 100a to exhibit its function, because of the irregularities of the undercoat layer 2 and the water-repellent resin 12 of the overcoat layer 3. In the case where the water-repellent coating 100a is formed on high-voltage equipment, however, the minute voids 9 formed between the spherical particles 5 and the base resin 6 or between the inorganic fine particles 7 and the base resin 6 of the undercoat layer 2 may serve as a starting point where dielectric breakdown is induced. If a short circuit occurs due to the dielectric breakdown, the short-circuited portion loses the super water repellency. In addition to the dielectric breakdown arising from the inside due to the voids 9, a surface current caused by, for example, a lightning strike may cause exposure of a hydrophilic substance contained in the substrate 1 or in the coating or a hydrophilic substance formed by the current, and water droplets may readily adhere thereto.

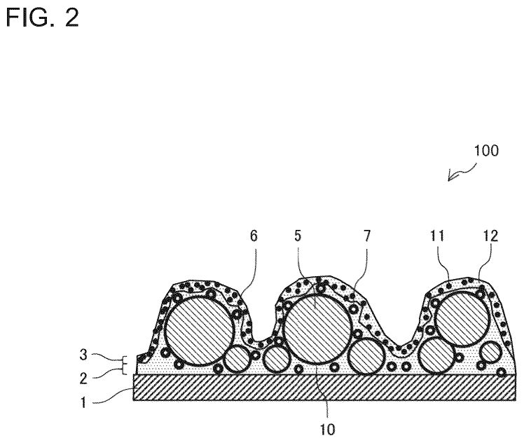

FIG. 2 is a sectional view illustrating the water-repellent coating 100 according to Embodiment 1. As illustrated in FIG. 2, the water-repellent coating 100 according to Embodiment 1 contains spherical particles 5, a base resin 6, inorganic fine particles 7, inorganic nanoparticles 11, a water-repellent resin 12, and an oil 10. The water-repellent coating 100 includes an undercoat layer 2 and an overcoat layer 3. The undercoat layer 2 contains the spherical particles 5, the inorganic fine particles 7, the oil 10, the spherical particles 5, and the base resin 6. The overcoat layer 3 contains the inorganic nanoparticles 11 and the water-repellent resin 12, and is formed on the undercoat layer 2.

Regarding the water-repellent coating 100, the overcoat layer 3 formed on the protruding portions of the undercoat layer 2 is worn when the surface of the water-repellent coating 100 is subjected to friction, but the overcoat layer 3 formed on the recessed portions of the undercoat layer 2 is not easily worn. As friction is repeated and wear progresses, the overcoat layer 3 is worn and the spherical particles 5 are partially exposed, but wear is not likely to further progress. Although small water droplets tend to be likely to adhere in the vicinity of the exposed spherical particles 5, the water repellency is maintained. This is because the spherical particles 5 have excellent wear resistance due to their surfaces having high smoothness, being compact, and having high hardness. Even when non-spherical particles are employed as the irregularity-forming particles, the irregularities of the undercoat layer 2 can be formed. In the case where the non-spherical particles are employed as the irregularity-forming particles, a great frictional force is generated between the friction-causing object and the irregularity-forming particles when the surface of the water-repellent coating 100 is subjected to friction, readily leading to detachment of the irregularity-forming particles or peeling of the undercoat layer 2. According to Embodiment 1, the undercoat layer 2 contains the oil 10 and therefore the adhesiveness between the irregularity-forming particles or the substrate 1 and the base resin 6 may decrease slightly. In the case where the non-spherical particles are employed as the irregularity-forming particles, the decrease in adhesiveness may lead to detachment of the particles or peeling. For this reason, the spherical particles 5 are employed in Embodiment 1. This reduces the likelihood of the detachment of the particles or peeling.

### (Spherical Particles 5)

The spherical particles 5 have an average particle diameter of 2 μm or more and 50 μm or less. Note that the spherical particles 5 preferably have an average particle diameter of 4 μm or more and 20 μm or less. When the average particle diameter of the spherical particles 5 is less than 2 μm, the irregularities of the undercoat layer 2 are too small to exert an effect of protecting the overcoat layer 3 against friction. When the average particle diameter of the spherical particles 5 is more than 50 μm, the irregularities of the undercoat layer 2 are too large and a problem may arise such as foreign matter stuck in the recessed portions of the overcoat layer 3, which prevents the water-repellent coating 100 from exhibiting its performance. Note that the average particle diameter of the spherical particles 5 is determined with a laser diffraction particle diameter analyzer.

The spherical particles 5 are at least one kind selected from the group consisting of spherical fused silica particles, spherical fused alumina particles, and spherical silicone resin particles. As seen from the above, the spherical fused silica particles or spherical fused alumina particles, which are generally used, may be employed as the spherical particles 5. Note that employing the above-described particles with their surfaces treated to be hydrophobic with a silylating agent, a silane coupling agent, or other agent can further improve the wear resistance. The use of the spherical fused silica particles or spherical fused alumina particles treated to be hydrophobic can increase the water repellency of the surface that is to be exposed due to wear, and therefore the effect of maintaining the water repellency can be improved. The hydrophobization treatment is particularly effective to the spherical fused silica particles. This improves the compatibility with the oil 10, reducing formation of the voids 9 between the spherical particles 5 and the base resin 6.

As described above, the spherical silicone resin particles may be employed as the spherical particles 5. Since the spherical silicone resin particles exhibit high water repellency, the surface to be exposed after wear has also the water repellency and thus the water repellency is readily maintained. As compared to the spherical fused silica particles and spherical fused alumina particles, the spherical silicone resin particles are disadvantageously likely to be worn by friction with a substance of high hardness such as sand interposed therebetween. However, the spherical silicone resin particles are advantageous in that they provide a pleasant feeling of touch, and a low frictional resistance during friction. In addition, spherical silicone resin particles are compatible with the oil 10, reducing formation of the voids 9.

### (Base Resin 6)

Examples of the base resin 6 include a polyurethane resin, a fluororesin, a silicone resin, various polyolefins such as polypropylene and polyethylene, polyvinyl chloride, an acrylic resin, a methacrylic resin, polystyrene, an ABS resin, and an AS resin. These resins may be employed alone or in combination of two or more as the base resin 6. The polyurethane resin is particularly preferable due to its excellent wear resistance. The fluororesin and the silicone resin are preferable due to their excellent water repellency. A resin with a substituent or the like introduced thereto may be employed for improvement in adhesiveness between the base resin 6 and the substrate 1.

### (Inorganic Fine Particles 7)

The inorganic fine particles 7 have an average particle diameter of 1 μm or more and 15 μm or less, and less than the average particle diameter of the spherical particles 5. This allows formation of irregularities smaller than the irregularities formed by the spherical particles 5. Such irregularities exert an effect of anchoring the overcoat layer 3 formed on the undercoat layer 2. Accordingly, the overcoat layer 3 is not likely to peel from the undercoat layer 2, and high water repellency is readily maintained even after friction is repeated.

According to Embodiment 1, the inorganic fine particles 7 are porous particles. Examples of the porous particles include porous particles of silica gel, precipitated silica, calcium silicates such as xonotlite and tobermorite, hydrated aluminas such as boehmite, and lime-based materials such as quicklime and slaked lime. The porous particles as the inorganic fine particles 7 may be employed alone or in combination of two or more. Silica gel and precipitated silica are particularly preferable in that they have appropriate strength and exhibit good dispersibility in the undercoat layer 2.

Since the inorganic fine particles 7 are generally hydrophilic, their surfaces are preferably subjected to a hydrophobization treatment before use. Examples of the hydrophobization treatment method include causing a silylating agent such as hexamethyldisilazane or a silane coupling agent to react with the inorganic fine particles 7. Hydrophobization of the surfaces of the inorganic fine particles 7 further reduces the decrease in hydrophobicity even after the surface is worn due to friction or other stimuli. It is also preferable that the inorganic fine particles 7 being porous particles be mixed with a fluororesin or silicone resin solution and dried, thereby impregnating the interiors of the inorganic fine particles 7 being porous particles with the fluororesin or silicone resin. The use of the inorganic fine particles 7 being porous particles impregnated with the fluororesin or silicone resin reduces the decrease in water repellency even after the surfaces of the inorganic fine particles 7 being porous particles are worn due to friction or other stimuli.

The inorganic fine particles 7 being porous particles are easily crushed due to wear because of their porosity, and thus do not affect the wear-reducing effect of the spherical particles 5 or the characteristic of ensuring flatness of the worn surface. In addition, crushed surfaces of the inorganic fine particles 7 being porous particles facilitate adhesion thereto of the water-repellent resin 12 of the overcoat layer 3, so that high water repellency is maintained. When the average particle diameter of the inorganic fine particles 7 is less than 1 μm, the worn surface may tend to become hydrophilic. When the average particle diameter of the inorganic fine particles 7 is more than 15 μm, a large hydrophilic surface may be formed upon crushing, and water may readily adhere thereto. Note that the average particle diameter of the inorganic fine particles 7 is determined with a laser diffraction particle diameter distribution analyzer.

The inorganic fine particles 7 have an effect of retaining the oil 10 inside their pores when they are porous, or in gaps between the particles when they are not porous. When mixed with the base resin 6, the oil 10 may decrease the strength of the resin. If the oil 10 is excessively present at the interface between the base resin 6 and the spherical particles 5 or the substrate 1, the adhesiveness may decrease, and the wear resistance of the coating may decrease. In addition, the oil may bleed out to the surface of the coating to cause adhesion of dust. According to Embodiment 1, the oil 10 is retained inside the inorganic fine particles 7 or in gaps therebetween, and therefore occurrence of the above-described problem is reduced.

### (Oil 10)

The inorganic fine particles 7 are impregnated with the oil 10. When the oil 10 is retained inside the inorganic fine particles 7 or in gaps therebetween, the oil 10 has a higher degree of freedom as liquid than when mixed with the base resin 6 or when present as a thin layer at the interface between the base resin 6 and the spherical particles 5 or the substrate 1. When a hydrophilic surface is formed on the undercoat layer 2 because of, for example, breakage due to abrasion or a short circuit, the oil 10 can efficiently spread to convert the hydrophilic surface to a water-repellent surface.

Examples of the oil 10 include a silicone oil and a fluorinated oil. Examples of the silicone oil include a dimethyl silicone oil, an amino-modified silicone oil, an alkyl-modified silicone oil, an epoxy-modified silicone oil, and a higher fatty acid-modified silicone oil. Examples of the fluorinated oil include perfluoropolyether (PFPE) and polychlorotrifluoroethylene (PCTFE).

The amount of the oil 10 in the undercoat layer 2 is preferably 1% or more and 30% or less by weight ratio, more preferably 2% by mass or more and 20% by mass or less, relative to the total amount of the base resin 6 and the inorganic fine particles 7. When the mass ratio of the oil 10 is too small, the voids 9 formed between the base resin 6 and the spherical particles 5 or between the base resin 6 and the inorganic fine particles 7 may fail to be filled. When the mass ratio of the oil 10 is too large, excess oil 10 may bleed out to the surface of the water-repellent coating 100 and thus dirt may be formed, which may decrease the water repellency.

### (Undercoat Layer 2)

The undercoat layer 2 is formed by application of an undercoat layer-forming coating composition on the substrate 1, the composition containing the base resin 6, the spherical particles 5, the inorganic fine particles 7, the oil 10, and a solvent in which the base resin 6 is soluble or emulsifiable. The total amount of the base resin 6, the spherical particles 5, the inorganic fine particles 7, and the oil 10 is preferably 3% by mass or more and 60% by mass or less relative to the undercoat layer-forming coating composition. When the total amount of the base resin 6, the spherical particles 5, the inorganic fine particles 7, and the oil 10 is less than 3% by mass, the spherical particles 5 are likely to settle and accordingly the coating composition decreases in handleability. Furthermore, the spherical particles 5 may fail to be fixed stably within the undercoat layer 2. When the total amount of the base resin 6, the spherical particles 5, the inorganic fine particles 7, and the oil 10 is more than 60% by mass, it may be difficult to uniformly form the undercoat layer 2.

The mass ratio of the spherical particles 5 to the base resin 6 in the undercoat layer 2 is preferably 10% by mass or more and 500% by mass or less, more preferably 30% by mass or more and 200% by mass or less. When the mass ratio of the spherical particles 5 is less than 10% by mass, the undercoat layer 2 cannot have sufficient irregularities and thus the water repellency may be insufficient. When the mass ratio of the spherical particles 5 is more than 500% by mass, the strength of the undercoat layer 2 may be insufficient.

15 The mass ratio of the inorganic fine particles 7 to the base resin 6 in the undercoat layer 2 is preferably 10% by mass or more and 200% by mass or less, more preferably 20% by mass or more and 100% by mass or less. When the mass ratio of the inorganic fine particles 7 is less than 10% by mass, an effect of reducing peeling of the overcoat layer 3 may be insufficient. When the mass ratio of the inorganic fine particles 7 is more than 200% by mass, the strength of the undercoat layer 2 may be 20 insufficient.

A crosslinker may be added to the undercoat layer-forming coating composition for improvement in the strength of the base resin 6. In addition, a common additive may be added to the undercoat layer-forming coating composition for improvement in coatability, or improvement in water repellency of the base resin 6. The undercoat layer-forming coating composition is applied by spray coating, brush coating, or roller brush coating. The average thickness of the undercoat layer 2 is preferably ⅓ times or more and 5 times or less the average particle diameter of the spherical particles 5. When the thickness of the undercoat layer 2 is less than ⅓ times the average particle diameter of the spherical particles 5, the wear resistance may be insufficient. When the thickness of the undercoat layer 2 is more than 5 times the average particle diameter of the spherical particles 5, the strength of the undercoat layer 2 may decrease and the water-repellent coating 100 may have a poor appearance.

### (Inorganic Nanoparticles 11)

Examples of the inorganic nanoparticles 11 include silica, alumina, zirconia, and titania. Since the surfaces of the inorganic nanoparticles 11 are generally hydrophilic, the surfaces are preferably subjected to a hydrophobization treatment before use. Examples of the hydrophobization treatment method include causing a silylating agent such as hexamethyldisilazane or a silane coupling agent to react with the inorganic nanoparticles 11. Such a method is preferable because highly stable hydrophobic properties are given. Other examples of the hydrophobization treatment method include mixing a silicone compound or fluorocarbon compound having a molecular weight lower than that of the water-repellent resin 12 with the inorganic nanoparticles 11 to cause the surfaces to adsorb the compound. Alternatively, it is also preferable to decrease the hydrophilicity of the inorganic nanoparticles 11 by heating, in place of the hydrophobization treatment. Heating the inorganic nanoparticles 11 to 150 degrees C. or more, preferably 300 degrees C. or more, decreases the hydrophilicity, facilitating development of the water repellency of the overcoat layer 3.

The average particle diameter of primary particles of the inorganic nanoparticles 11 is 2 nm or more and 20 nm or less, preferably 5 nm or more and 15 nm or less. When the average particle diameter of the primary particles of the inorganic nanoparticles 11 is less than 2 nm, it is difficult to prepare the overcoat layer-forming coating composition and the water repellency of the water-repellent coating 100 is insufficient. When the average particle diameter of the primary particles of the inorganic nanoparticles 11 is more than 20 nm, the water repellency of the water-repellent coating 100 is insufficient, and the water repellency is readily lost by repetition of friction. Note that the average particle diameter of the inorganic nanoparticles 11 is determined with a laser diffraction particle diameter distribution analyzer.

### (Water-Repellent Resin 12)

The water-repellent resin 12 is a fluororesin or a silicone resin. Alternatively, the water-repellent resin 12 may be, for example, a resin such as an acrylic resin, a urethane resin, or an epoxy resin the surface of which is made water-repellent by mixing a fluorinated additive or other agent. In particular, the fluororesin and the silicone resin are preferable in that they have excellent water repellency.

The mass ratio of the inorganic nanoparticles 11 to the water-repellent resin 12 in the overcoat layer 3 is preferably in a range from 40:60 to 95:5, more preferably in a range from 50:50 to 90:10. When the mass ratio of the inorganic nanoparticles 11 is too large, the overcoat layer 3 may be brittle and the wear resistance may decrease. When the mass ratio of the water-repellent resin 12 is too large, the water repellency may be insufficient.

### (Overcoat Layer 3)

The overcoat layer 3 is formed by application of an overcoat layer-forming coating composition on the undercoat layer 2, the composition containing the inorganic nanoparticles 11, the water-repellent resin 12, and a solvent in which the water-repellent resin 12 is soluble. The total amount of the inorganic nanoparticles 11 and the water-repellent resin 12 is preferably 0.3% by mass or more and 70% by mass or less, more preferably 0.5% by mass or more and 50% by mass or less, relative to the overcoat layer-forming coating composition. When the total amount of the inorganic nanoparticles 11 and the water-repellent resin 12 is less than 0.3% by mass, the overcoat layer 3 may be thin and therefore the water repellency may be insufficient. When the total amount of the inorganic nanoparticles 11 and the water-repellent resin 12 is more than 70% by mass, a coating having many cracks is likely to be formed, and the overcoat layer 3 may easily peel. In preparation of the overcoat layer-forming coating composition, it is preferable to use a submersible disperser, such as a homogenizer, a dissolver, or a high-pressure disperser, so that the inorganic nanoparticles 11 do not remain as large aggregates. As to the solvent (medium), it is sufficient that an appropriate one, the boiling point and viscosity of which are suitable for the coating method, be selected from those in which the water-repellent resin 12 is soluble.

The overcoat layer-forming coating composition is applied by spray coating, brush coating, or roller brush coating. The thickness of the overcoat layer 3 is preferably controlled so that the amount of the water-repellent resin 12 per 100 cm² after drying is 0.03 g or more and 1.2 g or less. When the amount of the water-repellent resin 12 is less than 0.03 g, the undercoat layer 2 may be exposed and the water repellency may be insufficient. When the amount of the water-repellent resin 12 is more than 1.2 g, the water repellency may decrease due to friction, or the overcoat layer 3 may be likely to peel.

Even the overcoat layer 3 alone has high water repellency, that is, super water repellency with a contact angle of water of 140 degrees or more. This is due to the fine irregularities formed by the inorganic nanoparticles 11 and the water repellency of the water-repellent resin 12. Note that the contact angle of water is determined by the following method. A water droplet of approximately 5 μL is dropped onto the surface of the water-repellent coating 100 from the tip of a needle coated with PTFE (polytetrafluoroethylene) having an inner diameter of 0.1 mm, and the contact angle is determined with a contact angle meter (model CX-150 manufactured by Kyowa Interface Science Co., Ltd.).

### (Substrate 1)

The substrate 1 on which the water-repellent coating 100 is to be formed may be used as various parts of a product required to have water-repelling performance. Examples of the product required to have water-repelling performance include outdoor power distribution equipment, electrical equipment, an electric cable, a snow-dividing roof, a heat exchanger of an outdoor unit of an air conditioner, a solar battery, and a radome. Examples of the material of the substrate 1 include unsaturated polyester, polyethylene, crosslinked polyethylene, polyvinyl chloride, polyimide, polypropylene, and polystyrene. Examples of the material of the substrate 1 further include, for example, plastics such as an ABS resin, an AS resin, a fluororesin, and a silicone resin, metals such as aluminum and stainless steel, glass, and porcelain.

With the above-described water-repellent coating 100 formed on the substrate 1, irregularities are formed due to the spherical particles 5, and at the same time, the fine irregularities due to the inorganic nanoparticles 11 and the water-repellent resin 12 contribute to development of high water repellency, and the oil 10 allows the coating to readily maintain the water repellency. The water-repellent coating 100 contains the oil 10. Due to permeation of the oil 10, the high water repellency can be maintained and adhesion of water droplets is reduced. Accordingly, deterioration by friction is not easily caused, and even when the super water repellency decreases locally, the initial performance can be maintained.

The oil 10 can fill the minute voids 9 between the spherical particles 5 and the base resin 6, or between the inorganic fine particles 7 and the base resin 6. Since the voids 9 are filled, starting points of short circuits can be reduced. When a hydrophilic substance is exposed due to a short circuit or other causes, the exposed surface of the hydrophilic substance can be made water-repellent through permeation of the oil 10, and therefore, high water repellency can be maintained and adhesion of water droplets can be reduced. In the case where a portion to which water droplets readily adhere is formed, a contaminant adhering thereto may cause the portion with deteriorated super water repellency to spread, and the water droplets adhering thereto may be likely to cause another short circuit. For the water-repellent coating 100 according to Embodiment 1, however, the oil 10 can reduce adhesion of water droplets. This can reduce spreading of the portion with deteriorated super water repellency due to a contaminant adhering thereto, and reduce the likelihood of another short circuit due to water droplets adhering thereto. The water-repellent coating 100 according to Embodiment 1 is formed on various articles and appropriately used.

### Embodiment 2

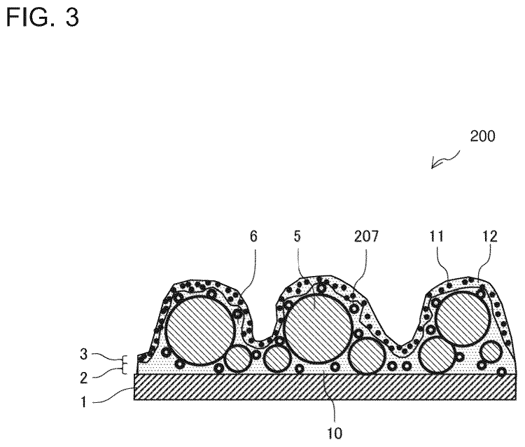

FIG. 3 is a sectional view illustrating a water-repellent coating 200 according to Embodiment 2. Embodiment 2 differs from Embodiment 1 in that inorganic fine particles 207 are fluororesin particles. In Embodiment 2, components common to those of Embodiment 1 will be denoted by the same reference signs and the description thereof will be omitted, and different points as compared to Embodiment 1 will be mainly described.

The fluororesin particles are soft and have a characteristic of being easily stretched by friction. When the inorganic fine particles 207 start to be exposed because of wear of the undercoat layer 2, the fluororesin particles are stretched over the worn surface due to friction, so that high water repellency is imparted to the worn surface. While high water repellency is imparted to the worn surface in this manner, the overcoat layer 3 remains without peeling in portions other than the worn surface. Hence, the water repellency is less likely to decrease even when the surface is worn. In the case where the fluororesin particles are employed as the inorganic fine particles 207 as in Embodiment 2, it is further preferable that the oil 10 be a fluorinated oil. The fluororesin particles and the fluorinated oil are compatible with each other, which can further reduce formation of the voids 9.

The inorganic fine particles 207 are fluororesin particles having an average particle diameter of 0.05 μm or more and 15 μm or less. With the fluororesin particles having an average particle diameter smaller than that of the spherical particles 5, irregularities smaller than the irregularities formed by the spherical particles 5 can be formed. The fluororesin particles are easily stretched by friction, and therefore do not affect the wear-reducing effect of the spherical particles 5 or the characteristic of ensuring flatness of the worn surface. When the average particle diameter of the inorganic fine particles 207 is less than 0.05 μm, the strength of the undercoat layer 2 may decrease and the adhesiveness between the substrate 1 and the undercoat layer 2 may decrease, and therefore, the undercoat layer 2 may readily wear or peel. When the average particle diameter of the inorganic fine particles 207 is more than 15 μm, the strength of the undercoat layer 2 may decrease. Note that the diameter of the fluororesin particles is determined with a laser diffraction particle diameter distribution analyzer. Here, primary particles of the fluororesin particles may have an average particle diameter of 0.05 μm or more and 15 μm or less and less than the average particle diameter of the spherical particles 5. Secondary particles (aggregates of primary particles having an average particle diameter of several tens of nanometers to several hundreds of nanometers) of the fluororesin particles may have an average particle diameter of 0.05 μm or more and 15 μm or less and less than the average particle diameter of the spherical particles 5.

The content of the inorganic fine particles 207 in the undercoat layer 2 is preferably 5% by mass or more and 100% by mass or less relative to the content of the spherical particles 5. When the content of the inorganic fine particles 207 is less than 5% by mass, the effect of forming fine irregularities may be insufficient to provide the effect of reducing peeling of the overcoat layer 3. On the other hand, when the content of the inorganic fine particles 207 is more than 100% by mass, the undercoat layer 2 may be soft, and thus the wear resistance may decrease.

The mass ratio of the spherical particles 5 to the base resin 6 in the undercoat layer 2 is preferably 10% by mass or more and 500% by mass or less, more preferably 30% by mass or more and 200% by mass or less. When the mass ratio of the spherical particles 5 is less than 10% by mass, the undercoat layer 2 does not have sufficient irregularities, and thus the water repellency may be insufficient. When the mass ratio of the spherical particles 5 is more than 500% by mass, the strength of the undercoat layer 2 may be insufficient.

The mass ratio of the oil 10 to the total amount of the base resin 6 and the fluororesin particles in the undercoat layer 2 is preferably 1% by mass or more and 30% by mass or less, more preferably 2% by mass or more and 20% by mass or less. When the mass ratio of the oil 10 is too small, the voids 9 that may be formed between the base resin 6 and the spherical particles 5 or between the base resin 6 and the fluororesin particles may fail to be filled. When the mass ratio of the oil 10 is too large, excess oil 10 may bleed out to the surface of the water-repellent coating 200 and thus dirt may be formed, which may decrease the water repellency.

The undercoat layer 2 of the water-repellent coating 200 is formed by application of an undercoat layer-forming coating composition on the substrate 1, the composition containing the base resin 6, the spherical particles 5, the fluororesin particles, the oil 10, and a solvent in which the base resin 6 is soluble or emulsifiable. Examples of a method of adding the fluororesin particles to the undercoat layer-forming coating composition include mixing the fluororesin particles in a powder form with the base resin 6, the spherical particles 5, the oil 10, and the solvent. Alternatively, a dispersion of the fluororesin particles may be mixed with the base resin 6, the spherical particles 5, the oil 10, and the solvent.

The total amount of the base resin 6, the spherical particles 5, the fluororesin particles, and the oil 10 is preferably 3% by mass or more and 65% by mass or less relative to the undercoat layer-forming coating composition. When the total amount of the base resin 6, the spherical particles 5, the fluororesin particles, and the oil 10 is less than 3% by mass, the spherical particles 5 are likely to settle and thus the handleability of the coating composition decreases, and furthermore, the spherical particles 5 may fail to be stably fixed within the undercoat layer 2. When the total amount of the base resin 6, the spherical particles 5, the fluororesin particles, and the oil 10 is more than 65% by mass, it may be difficult to uniformly form the undercoat layer 2. A crosslinker may be added to the undercoat layer-forming coating composition for improvement in the strength of the base resin 6. In addition, a common additive may be added to the undercoat layer-forming coating composition for improvement in coatability, or improvement in water repellency of the base resin 6.

With the above-described water-repellent coating 200 formed on the substrate 1, irregularities are formed due to the spherical particles 5, and at the same time, the fine irregularities due to the inorganic nanoparticles 11 and the water-repellent resin 12 contribute to development of high water repellency, and the oil 10 allows the coating to readily maintain the water repellency. In Embodiment 2 as well, the water-repellent coating contains the oil 10. Due to permeation of the oil 10, the high water repellency can be maintained and adhesion of water droplets can be reduced. Accordingly, deterioration by friction is not readily caused, and even when the super water repellency decreases locally, the initial performance can be maintained. Since the undercoat layer 2 contains the fluororesin particles as the inorganic fine particles 207 having a specific average particle diameter, irregularities are formed on the surface of the undercoat layer 2, and an effect of reducing peeling of the overcoat layer 3 from the undercoat layer 2 can be achieved, as described in Embodiment 1. Note that the method of applying the undercoat layer-forming coating composition, the thickness of the undercoat layer 2, the composition of the overcoat layer 3, the method of applying the overcoat layer-forming coating composition, and the thickness of the overcoat layer 3 are the same as those of Embodiment 1.

### Embodiment 3

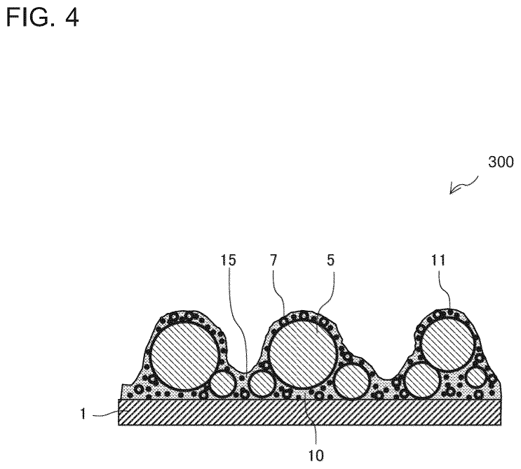

FIG. 4 is a sectional view illustrating a water-repellent coating 300 according to Embodiment 3. Embodiment 3 differs from Embodiments 1 and 2 in that the water-repellent coating 300 is formed of a single layer. In Embodiment 3, components common to those of Embodiments 1 and 2 will be denoted by the same reference signs and the description thereof will be omitted, and different points as compared to Embodiments 1 and 2 will be mainly described.

The water-repellent coating 300 contains spherical particles 5, inorganic fine particles 7, inorganic nanoparticles 11, a water-repellent resin 15, and an oil 10. Note that porous particles are employed as the inorganic fine particles 7.

### (Spherical Particles 5)

The average particle diameter of the spherical particles 5 contained in the water-repellent coating 300 is 2 μm or more and 50 μm or less, preferably 4 μm or more and 20 μm or less. When the average particle diameter of the spherical particles 5 is less than 2 μm, the irregularities of the water-repellent coating 300 are too small and thus the water-repellent coating 300 having water repellency in recessed portions cannot be protected against friction. When the average particle diameter of the spherical particles 5 is more than 50 μm, the irregularities of the water-repellent coating 300 are too large and a problem may arise such as foreign matter stuck in the recessed portions of the water-repellent coating 300, which prevents the water-repellent coating 300 from exhibiting its performance. Note that the average particle diameter of the spherical particles 5 is determined with a laser diffraction particle diameter analyzer.

Preferably employed as the spherical particles 5 are spherical fused silica particles or spherical fused alumina particles with their surfaces treated to be hydrophobic with a silylating agent, a silane coupling agent, or other agent. With the spherical fused silica particles or spherical fused alumina particles treated to be hydrophobic, the water repellency of the surface that is to be exposed due to wear can be increased, and therefore the effect of maintaining the water repellency can be improved. In particular, the hydrophobization treatment is effective to the spherical fused silica particles. This improves the compatibility with the oil 10, reducing formation of voids 9 between the spherical particles 5 and a base resin 6.

Spherical silicone resin particles may be employed as the spherical particles 5. Since the spherical silicone resin particles have excellent water repellency, the surface to be exposed after wear has also the water repellency and thus the water repellency is readily maintained. As compared to the spherical fused silica particles and spherical fused alumina particles, the spherical silicone resin particles are disadvantageously likely to be worn by friction with a substance of high hardness such as sand interposed. However, the spherical silicone resin particles provide advantages including a pleasant feeling of touch, and a low frictional resistance during friction. In addition, spherical silicone resin particles are compatible with the oil 10, reducing formation of the voids 9.

### (Inorganic Fine Particles 7)

According to Embodiment 3, the inorganic fine particles 7 are porous particles. Examples of the porous particles include porous particles of silica gel, precipitated silica, calcium silicates such as xonotlite and tobermorite, hydrated aluminas such as boehmite, and lime-based materials such as quicklime and slaked lime. The porous particles as the inorganic fine particles 7 may be employed alone or in combination of two or more. Silica gel and precipitated silica are particularly preferable in that they have appropriate strength and exhibit good dispersibility in the water-repellent coating 300.

Since the inorganic fine particles 7 are generally hydrophilic, their surfaces are preferably subjected to a hydrophobization treatment before use. Examples of the hydrophobization treatment method include causing a silylating agent such as hexamethyldisilazane or a silane coupling agent to react with the inorganic fine particles 7. Hydrophobization of the surfaces of the inorganic fine particles 7 further reduces the decrease in hydrophobicity even after the surface is worn due to friction or other stimuli.

The water-repellent coating 300 can be formed even if the composition does not contain the porous particles. In this case, however, the strength and the wear resistance of the coating tend to be lower. In particular, the decrease in the strength and the wear resistance of the coating is significant when the oil 10 is contained. In Embodiment 3, the porous particles are added and thereby the strength of the coating can be improved, and in particular, the coating can have high strength even when the coating contains the oil 10. In addition, porous particles 16 have effects of improving the strength of the coating containing the oil 10 added thereto and facilitating hydrophobization when the water-repellent coating 300 is damaged and a hydrophilic surface is formed. This is for the same reason as in Embodiment 1.

While having the effect of improving the strength of the water-repellent coating 300, the porous particles are easily crushed due to wear and therefore do not affect the wear-reducing effect of the spherical particles 5 or the characteristic of ensuring flatness of the worn surface. Crushed surfaces of the porous particles are impregnated with the oil 10, which maintains high water repellency. When the average particle diameter of the porous particles is less than 1 μm, the worn surface may tend to become hydrophilic. When the average particle diameter of the porous particles is more than 5 μm, a large hydrophilic surface may be formed upon crushing, and water may readily adhere thereto. Note that the average particle diameter of the inorganic fine particles 7 is determined with a laser diffraction particle diameter distribution analyzer.

### (Inorganic Nanoparticles 11)

Examples of the inorganic nanoparticles 11 include silica, alumina, zirconia, and titania nanoparticles. Since the surfaces of the inorganic nanoparticles 11 are generally hydrophilic, the surfaces are preferably subjected to a hydrophobization treatment before use. Examples of the hydrophobization treatment method include causing a silylating agent such as hexamethyldisilazane or a silane coupling agent to react with the inorganic nanoparticles 11. Such a method is preferable because highly stable hydrophobic properties are given. Other examples of the hydrophobization treatment method include mixing a silicone compound or fluorocarbon compound having a molecular weight lower than that of the water-repellent resin 15 with the inorganic nanoparticles 11 to cause the surfaces to adsorb the compound. Alternatively, it is also preferable to decrease the hydrophilicity of the inorganic nanoparticles 11 by heating, in place of the hydrophobization treatment. Heating the inorganic nanoparticles 11 to 150 degrees C. or more, preferably 300 degrees C. or more, decreases the hydrophilicity, facilitating development of the water repellency of the water-repellent coating 300.

The average particle diameter of primary particles of the inorganic nanoparticles 11 is 2 nm or more and 20 nm or less, preferably 5 nm or more and 15 nm or less. When the average particle diameter of the primary particles of the inorganic nanoparticles 11 is less than 2 nm, it is difficult to prepare the overcoat layer-forming coating composition and the water repellency of the water-repellent coating 300 is insufficient. When the average particle diameter of the primary particles of the inorganic nanoparticles 11 is more than 20 nm, the water repellency of the water-repellent coating 300 is insufficient, and the water repellency is readily lost by repetition of friction. Note that the average particle diameter of the inorganic nanoparticles 11 is determined with a laser diffraction particle diameter distribution analyzer.

### (Oil 10)

Examples of the oil 10 include a silicone oil and a fluorinated oil. Examples of the silicone oil include a dimethyl silicone oil, an amino-modified silicone oil, an alkyl-modified silicone oil, an epoxy-modified silicone oil, and a higher fatty acid-modified silicone oil. Examples of the fluorinated oil include perfluoropolyether (PFPE) and polychlorotrifluoroethylene (PCTFE).

### (Water-Repellent Resin 15)

In the case where a fluororesin is employed as the water-repellent resin 15 and a silicone oil is employed as the oil 10, since the fluororesin and the silicone oil are not miscible with each other, the silicone oil tends to be unevenly distributed around the spherical particles 5 or the inorganic nanoparticles 11, and accordingly, formation of the voids 9 can be readily reduced.

The mass ratio of the spherical particles 5 to the water-repellent resin 15 in the water-repellent coating 300 is preferably 10% by mass or more and 500% by mass or less, more preferably 30% by mass or more and 200% by mass or less. When the mass ratio of the spherical particles 5 is less than 10% by mass, the water-repellent coating 300 cannot have sufficient irregularities and thus the water repellency may be insufficient. When the mass ratio of the spherical particles 5 is more than 500% by mass, the strength of the water-repellent coating 300 may be insufficient.

The mass ratio of the inorganic nanoparticles 11 to the water-repellent resin 15 in the water-repellent coating 300 is preferably 5% by mass or more and 200% by mass or less, more preferably 10% by mass or more and 100% by mass or less. When the mass ratio of the inorganic nanoparticles 11 is less than 5% by mass, the water repellency may be insufficient after the water-repellent coating 300 is worn. When the mass ratio of the inorganic nanoparticles 11 is more than 200% by mass, the strength of the water-repellent coating 300 may be insufficient.

The mass ratio of the porous particles serving as the inorganic fine particles 7 to the water-repellent resin 15 in the water-repellent coating 300 is preferably 5% by mass or more and 200% by mass or less, more preferably 10% by mass or more and 100% by mass or less. When the mass ratio of the porous particles is less than 5% by mass, the water repellency may be insufficient after the water-repellent coating 300 is worn. When the mass ratio of the porous particles is more than 200% by mass, the strength of the water-repellent coating 300 may be insufficient.

The mass ratio of the oil 10 to the total amount of the water-repellent resin 15, the inorganic fine particles 7, and the inorganic nanoparticles 11 in the water-repellent coating 300 is preferably 1% by mass or more and 30% by mass or less, more preferably 2% by mass or more and 20% by mass or less. When the mass ratio of the oil 10 is too small, the voids 9 formed between the water-repellent resin 15 and the spherical particles 5, between the water-repellent resin 15 and the inorganic nanoparticles 11, or between the water-repellent resin 15 and the porous particles may fail to be filled. When the mass ratio of the oil 10 is too large, excess oil 10 may bleed out to the surface of the water-repellent coating 300 and thus dirt may be formed, which may decrease the water repellency.

The water-repellent coating 300 is formed by application of a water-repellent coating-forming coating composition on a substrate 1, the composition containing the spherical particles 5, the inorganic nanoparticles 11, the porous particles, the water-repellent resin 15, the oil 10, and a solvent (medium) in which the water-repellent resin 15 is soluble and with which the oil 10 is miscible. The total amount of the spherical particles 5, the inorganic nanoparticles 11, the porous particles, the water-repellent resin 15, and the oil 10 is preferably 3% by mass or more and 70% by mass or less relative to the water-repellent coating-forming coating composition. When the total amount of the spherical particles 5, the inorganic nanoparticles 11, the porous particles, the water-repellent resin 15, and the oil 10 is less than 3% by mass, the spherical particles 5 are likely to settle and accordingly the coating composition decreases in handleability.

Furthermore, the spherical particles 5 may fail to be fixed stably within the water-repellent coating 300. When the total amount of the spherical particles 5, the inorganic nanoparticles 11, the porous particles, the water-repellent resin 15, and the oil 10 is more than 70% by mass, it may be difficult to uniformly form the water-repellent coating 300.

A crosslinker may be added to the water-repellent coating-forming coating composition for improvement in the strength of the water-repellent coating 14. In addition, a common additive may be added to the water-repellent coating-forming coating composition for improvement in coatability, or improvement in water repellency. In preparation of the water-repellent coating-forming coating composition, it is preferable to use a submersible disperser, such as a homogenizer, a dissolver, or a high-pressure disperser, so that the inorganic nanoparticles 11 do not remain as large aggregates.

The water-repellent coating-forming coating composition is applied by spray coating, brush coating, or roller brush coating. The average thickness of the water-repellent coating 300 is preferably ⅓ times or more and 5 times or less the average particle diameter of the spherical particles 5. When the thickness of the water-repellent coating 300 is less than ⅓ times the average particle diameter of the spherical particles 5, the wear resistance may be insufficient. When the thickness of the undercoat layer 2 is more than 5 times the average particle diameter of the spherical particles 5, the strength of the water-repellent coating 300 may decrease and the water-repellent coating 300 may have a poor appearance.

With the above-described water-repellent coating 300 formed on the substrate 1, a coating that readily maintains the water repellency can be obtained. In Embodiment 3 as well, the water-repellent coating contains the oil 10. Due to permeation of the oil 10, the high water repellency can be maintained and adhesion of water droplets is reduced. Accordingly, deterioration by friction is not readily caused, and even when the super water repellency decreases locally, the initial performance can be maintained.

In the water-repellent coating 300 according to Embodiment 3, when the surface of the water-repellent coating 300 is subjected to friction, the coating formed on the spherical particles 5 of the water-repellent coating 300 is worn, but the coating formed on the recessed portions of the water-repellent coating 300 is not easily worn. As friction is repeated and wear progresses, the spherical particles 5 are partially exposed, but wear is not likely to further progress. Although small water droplets tend to be likely to adhere in the vicinity of the exposed spherical particles 5, the water repellency is maintained. This is because the surface of the spherical particle 5 has high smoothness, is compact, and has high hardness, and thus has excellent wear resistance. In the water-repellent coating 300, the coating formed in portions other than the spherical particles 5 contains the inorganic fine particles 7 being porous particles, the inorganic nanoparticles 11, the water-repellent resin 15, and the oil 10, each of which has water repellency. Therefore, the exposed portion exhibits the water repellency even after wear progresses, and thus the decrease in the water repellency of the water-repellent coating 300 can be reduced.

### EXAMPLES

Examples and Comparative Examples are shown below to specifically describe the embodiments, but the embodiments are not limited by the following Examples.

### Examples 1 and 2 and Comparative Examples 1 and 2

Prepared was a mixed solution containing: 20% by mass of particles (average particle diameter: 3.5 μm) obtained by mixing spherical fused silica particles (made by Denka Company Limited) with hexamethyldisilazane, followed by drying for hydrophobization and then classification, as the spherical particles 5; 5% by mass of silica gel particles Nipgel AY-200 (average particle diameter: 2.1 μm, made by Tosoh Silica Corporation) as the inorganic fine particles 7; 10% by mass of a crosslinkable fluororesin (Bonnflon GT-SR, made by AGC Coat-Tech Co., Ltd.) as the base resin 6; and mineral spirit as the solvent. Dimethyl silicone (KF-96-3,000cs, made by Shin-Etsu Silicone Co., Ltd.) as the oil 10 was added to the mixed solution, thereby producing a coating material for undercoat. The amount of oil added shown in Table 1 is a value relative to the total amount of the inorganic fine particles 7 and the base resin 6.

Prepared was an overcoat liquid containing: silica nanoparticles (AEROSIL R 976, made by Nippon Aerosil Co., Ltd., average particle diameter in solvent: 12 nm) treated with dimethyldichlorosilane to be hydrophobic, as the inorganic nanoparticles 11; a silicone resin (KR221, made by Shin-Etsu Silicone Co., Ltd.) as the water-repellent resin 15; and xylene as a solvent. The overcoat liquid was applied onto a glass plate by spray coating and dried, thereby producing a coating having high water repellency with a contact angle of water of 145 degrees. This coating peels when rubbed only several times with a nonwoven fabric, and does not have wear resistance.

The coating material for undercoat was applied onto a surface of a mortar plate by spray coating. After a lapse of 24 hours from the application, the overcoat liquid was applied by spray coating. The coating formed was subjected to rubbing with a rod of stainless steel having a diameter of 5 mm, thereby exposing the base. Water was sprayed onto the exposed base immediately after the exposure and one day after the exposure, and the state of water droplets that adhered thereto was observed. In addition, electrode terminals were press-bonded onto the coating formed with a gap of 10 mm provided between the electrode terminals, and the surface of the coating was deteriorated by electric discharge at a high voltage. Water was sprayed immediately after the exposure and one day after the exposure, and the state of water droplets that adhered thereto was observed.

TABLE 1

| | | | | | Immediately | One day after |
|---|---|---|---|---|---|---|
| | Amount of | Contact | Immediately | One day after | after electric | electric |
| | oil added | angle | after rubbing | rubbing | discharge | discharge |
| Example 1 | 2% by | 148 | Water adhered | Adhered as | Water adhered | Adhered as |
| | mass | degrees | linearly | water droplets | linearly | water droplets |
| Example 2 | 10% by | 140 | Water droplets | Adhered as | Water adhered | No water |
| | mass | degrees | adhered | water droplets | linearly | droplet adhered |
| Comparative | No | 148 | Water adhered | Water adhered | Water adhered | Water adhered |
| Example 1 | addition | degrees | linearly | linearly | linearly | linearly |
| Comparative | 30% by | 120 | Water droplets | Water droplets | Water droplets | Water droplets |
| Example 2 | mass | degrees | adhered to | adhered to | adhered to | adhered to |
| | | | entire surface | entire surface | entire surface | entire surface |

In Examples 1 and 2, the coating obtained had high water repellency with a contact angle of water of 140 degrees or more. The damaged portion due to rubbing decreased in water repellency, and water adhered when the water was sprayed. In Example 1, water adhered linearly to cover the entire damaged portion, but in Example 2, water adhered not to the entire damaged portion but as fine water droplets. This is because the large amount of oil added thereto reduced the decrease in water repellency. Since the adhesion of water was also reduced in Example 1 one day after rubbing, it can be seen that the water repellency was recovered. Water adhered linearly to the entire discharge crater immediately after the electric discharge in both of Examples 1 and 2, but one day after the electric discharge, water droplets adhered in Example 1 and no water adhered in Example 2, showing that the water repellency was recovered.

Regarding Comparative Example 1, the oil 10 was not added to the coating. Although high contact angle was exhibited, the water repellency decreased due to rubbing or electric discharge, and was not recovered even after being left. The results show that the addition of the oil brings about effects of reducing the decrease in water repellency and recovering the water repellency. Comparative Example 2 is an example where the oil 10 was added in an excessive amount. The contact angle was low, and water droplets adhered to even non-damaged portions when water was sprayed. This shows that the oil 10 should be in an appropriate amount.

### Examples 3 and 4 and Comparative Examples 3 to 9

As the spherical particles 5, spherical fused silica particles (made by Denka Company Limited) were treated with hexamethyldisilazane to be hydrophobic to prepare particles of different average particle diameters. As the inorganic fine particles 7, fine particles of different average particle diameters were selected (Seahostar KE-P50: 0.5 μm made by Nippon Shokubai Co., Ltd., Nipgel AZ-204:1.3 μm, AY-200:2.1 μm, AY-601:6.0 μm made by Tosoh Silica Corporation). As the base resin 6, 10% by mass of a crosslinkable fluororesin (Bonnflon GT-SR, made by AGC Coat-Tech Co., Ltd.) was mixed, and as the oil 10, 2% by mass of dimethyl silicone (KF-96-3,000cs, made by Shin-Etsu Silicone Co., Ltd.) was mixed relative to the total amount of the base resin 6 and the inorganic fine particles 7, thereby preparing a coating material for undercoat in Table 2.

The coating material for undercoat was applied onto a surface of a mortar plate by spray coating, and after a lapse of 24 hours, the overcoat liquid of Example 1 was applied by spray coating. After the application, the coating was subjected to friction by rubbing the coating with a nonwoven fabric for wiping back and forth 10 times with a load of 80 g/cm². The contact angle of water was determined before and after the friction. The coating after the friction was subjected to strong rubbing with a rod of stainless steel having a diameter of 5 mm, thereby exposing the base. Water was sprayed onto the exposed base immediately after the exposure and one day after the exposure, and the state of water droplets that adhered thereto was observed. Table 2 shows the degree of deterioration of the coating due to friction confirmed in terms of the contact angle of water, and the water repellency of the coating that was damaged after the friction.

TABLE 2

| | | | Average | | | | | | |
|---|---|---|---|---|---|---|---|---|---|
| | Average | | particle | Amount of | | | | | |
| | particle | Amount of | diameter of | inorganic | Contact | Contact | | | |
| | diameter of | spherical | inorganic | fine | angle | angle | Immediately | One day | |
| | spherical | particles | fine | particles | after | after | after | after | |
| | particles | added | particles | added | coating | friction | rubbing | rubbing | Remarks |
| Example 3 | 3.5 μm | 20% by | 2.1 μm | 5% by | 148 | 140 | Water | Adhered as | The same |
| | | mass | | mass | degrees | degrees | adhered | water | coating as |
| | | | | | | | linearly | droplets | Example 1 in |
| | | | | | | | | | Table 1 |
| Example 4 | 3.5 μm | 20% by | 1.3 μm | 5% by | 150 | 145 | Water | Adhered as | |
| | | mass | | mass | degrees | degrees | adhered | water | |
| | | | | | | | linearly | droplets | |
| Comparative | 2.0 μm | 20% by | 1.3 μm | 5% by | 130 | 125 | Water | Water | Too small particle |
| Example 3 | | mass | | mass | degrees | degrees | droplets | droplets | diameter of |
| | | | | | | | adhered to | adhered to | spherical |
| | | | | | | | entire surface | entire surface | particles |
| Comparative | 20 μm | 20% by | 2.1 μm | 5% by | 145 | 111 | Water | Water | Too large particle |
| Example 4 | | mass | | mass | degrees | degrees | droplets | droplets | diameter of |
| | | | | | | | adhered to | adhered to | spherical |
| | | | | | | | entire surface | entire surface | particles |
| Comparative | 3.5 μm | 5% by | 2.1 μm | 5% by | 130 | 108 | Water | Water | Small amount of |
| Example 5 | | mass | | mass | degrees | degrees | droplets | droplets | spherical |
| | | | | | | | adhered to | adhered to | particles added |
| | | | | | | | entire surface | entire surface | |
| Comparative | 3.5 μm | 20% by | 2.1 μm | 0.1% by | 151 | 128 | Water | Water | Small amount of |
| Example 6 | | mass | | mass | degrees | degrees | droplets | droplets | inorganic fine |
| | | | | | | | adhered to | adhered to | particles added |
| | | | | | | | entire surface | entire surface | |
| Comparative | 3.5 μm | 20% by | 2.1 μm | 20% by | 97 | 110 | Water | Water | Too large amount |
| Example 7 | | mass | | mass | degrees | degrees | droplets | droplets | of inorganic fine |
| | | | | | | | adhered to | adhered to | particles added |
| | | | | | | | entire surface | entire surface | |
| Comparative | 3.5 μm | 15% by | 6.0 μm | 5% by | 88 | 90 | Water | Water | Too large particle |
| Example 8 | | mass | | mass | degrees | degrees | droplets | droplets | diameter of |
| | | | | | | | adhered to | adhered to | inorganic fine |
| | | | | | | | entire surface | entire surface | particles |
| Comparative | 3.5 μm | 15% by | 0.5 μm | 5% by | 130 | 110 | Water | Water | Too small particle |
| Example 9 | | mass | | mass | degrees | degrees | droplets | droplets | diameter of |
| | | | | | | | adhered to | adhered to | inorganic fine |
| | | | | | | | entire surface | entire surface | particles |

In Examples 3 and 4, the contact angle of water was more than 140 degrees even after friction, and it can be seen that high wear resistance was exhibited. The damaged portion was made hydrophilic immediately after the damage and water adhered linearly to cover the entire damage, but one day after the damage, the water repellency was recovered and merely small water droplets adhered.

Comparative Examples 3 to 5 show the effect of the spherical particles 5. Comparative Example 3 is an example where the particle diameter was too small, Comparative Example 4 is an example where the particle diameter was too large, and Comparative Example 5 is an example where the amount added was too small. In any of these cases, the contact angle decreased significantly due to the friction, and adhesion of water droplets was seen in the entire surface. It can be seen that a water-repellent coating having wear resistance cannot be obtained without employing appropriate spherical particles 5.

Comparative Examples 6 to 9 show the effect of the inorganic fine particles 7. Comparative Example 6 is an example where the amount added was small, Comparative Example 7 is an example where the amount added was too large, Comparative Example 8 is an example where the particle diameter was too large, and Comparative Example 9 is an example where the particle diameter was too small. In the case where the amount added was small, the hydrophilicity decreased due to friction. It can be seen that high water repellency cannot be achieved when the amount added is too large or the particle diameter is not appropriate.

### Example 5 and Comparative Example 10

A urethane dispersion (UW-5002E, made by Ube Corporation), a fluororesin dispersion (AD911E, made by AGC Inc.), or an acrylic emulsion (A-104, made by Toagosei Co., Ltd.) was employed as the base resin 6, spherical silica (average particle diameter: 3.6 μm, Denka Company Limited) or spherical alumina (average particle diameter: 4.3 μm, Denka Company Limited) was employed as the spherical particles 5, silica gel particles (Nipgel AY-200, average particle diameter: 2.1 μm, made by Tosoh Silica Corporation) were employed as the inorganic fine particles 7, and a silicone oil (KF-352A, made by Shin-Etsu Silicone Co., Ltd.) or a fluorinated oil (Demnum S-65 made by Daikin Industries, Ltd.) was employed as the oil 10. These materials were mixed with water in the ratios shown in Table 3 and then treated with a disperser, thereby preparing a coating material for undercoat. Note that the values in the column of the oil 10 denote mass ratios relative to the total amount of the base resin 6 and the inorganic fine particles 7.

The undercoat agent was applied onto a galvanized steel plate by spray coating, and dried at 130 degrees C. for 15 minutes. The overcoat liquid of Example 1 was then applied by spray coating. Thereafter, the friction and damage tests were performed as in Example 3.

TABLE 3

| | | | | | Contact | Contact | Immediately | One day |
|---|---|---|---|---|---|---|---|---|
| | | Spherical | Inorganic fine | | angle after | angle after | after | after |
| | Base resin | particles | particles | Oil | coating | friction | rubbing | rubbing |
| Example 5 | Urethane resin | Spherical | Silica gel | Silicone | 140 | 140 | Water | Adhered |
| | 20% by mass | silica | 5% by mass | 3% by mass | degrees | degrees | adhered | as water |
| | | 20% by | | | | | linearly | droplets |
| | | mass | | | | | | |
| Example 6 | Urethane resin | Spherical | Silica gel | Silicone | 142 | 141 | Water | Adhered |
| | 20% by mass | alumina | 5% by mass | 3% by mass | degrees | degrees | adhered | as water |
| | | 20% by | | | | | linearly | droplets |
| | | mass | | | | | | |
| Example 7 | Urethane resin | Spherical | Silica gel | Fluorinated | 141 | 140 | Water | Adhered |
| | 20% by mass | silica | 5% by mass | oil | degrees | degrees | adhered | as water |
| | | 20% by | | 5% by mass | | | linearly | droplets |
| | | mass | | | | | | |
| Example 8 | Fluororesin | Spherical | Silica gel | Silicone | 148 | 139 | Water | Adhered |
| | 20% by mass | silica | 5% by mass | 3% by mass | degrees | degrees | adhered | as water |
| | | 20% by | | | | | linearly | droplets |
| | | mass | | | | | | |
| Example 9 | Fluororesin | Spherical | Silica gel | Silicone | 145 | 140 | Water | Adhered |
| | 20% by mass | alumina | 5% by mass | 3% by mass | degrees | degrees | adhered | as water |
| | | 20% by | | | | | linearly | droplets |
| | | mass | | | | | | |
| Example 10 | Fluororesin | Spherical | Silica gel | Fluorinated | 146 | 137 | Water | Adhered |
| | 20% by mass | silica | 5% by mass | oil | degrees | degrees | adhered | as water |
| | | 20% by | | 5% by mass | | | linearly | droplets |
| | | mass | | | | | | |
| Comparative | Acrylic resin | Spherical | Silica gel | Fluorinated | 145 | 110 | Water | Water |
| Example 10 | 20% by mass | silica | 5% by mass | oil | degrees | degrees | adhered | adhered |
| | | 20% by | | 5% by mass | | | to entire | to entire |
| | | mass | | | | | surface | surface |

Each of Examples 5 to 10 is an example where a urethane resin or a fluororesin was employed as the base resin 6, silica or alumina was employed as the spherical particles 5, a silicone oil or a fluorinated oil was employed as the oil 10, and the materials were made into an aqueous coating material for undercoat. In these cases, high water repellency, wear resistance, and maintainability of water repellency upon being damaged were achieved. Comparative Example 10 is an example where an acrylic resin was employed as the base resin 6, as a result of which deterioration was easily caused by friction.

### Example 11 and Comparative Examples 11 and 12

A fluororesin (Bonnflon GT-SR, made by AGC Coat-Tech Co., Ltd.) was employed as the base resin 6, spherical silica (average particle diameter: 3.5 μm, 12 μm, Denka Company Limited) was employed as the spherical particles 5, fluororesin fine particles (Dyneon PTFE Micropowder TF9207Z, 4 μm, made by 3M Japan Limited) were employed as the inorganic fine particles 7, and a fluorinated oil (Demnum S-65 made by Daikin Industries, Ltd.) was employed as the oil 10 to prepare a coating material for undercoat containing mineral spirit as a solvent in the mixing ratios shown in Table 4. Note that the values in the column of the oil 10 denote mass ratios relative to the total amount of the base resin 6 and the inorganic fine particles 7.

Silica nanoparticles (AEROSIL R 976, made by Nippon Aerosil Co., Ltd., average particle diameter 12 nm) treated with dimethyldichlorosilane to be hydrophobic were employed as the inorganic nanoparticles 11, a fluororesin (FS-1610, made by Fluoro Technology Co., Ltd.) was employed as the water-repellent resin 15, and a fluorinated solvent (AE-3000, made by AGC Inc.) was employed as a solvent to prepare an overcoat liquid. The overcoat liquid was applied onto a glass plate by spray coating and dried, thereby producing a coating having high water repellency with a contact angle of water of 155 degrees. This coating peels when rubbed only several times with a nonwoven fabric, and does not have wear resistance. The coating liquid is a fluorinated solvent and thus can be applied to even an undercoat being an uncured resin without deterioration of the undercoat. The undercoat agent was applied onto a galvanized steel plate by spray coating, and one day after the application, the overcoat agent was applied by spraying. Thereafter, the friction and damage tests were performed as in Example 3.

TABLE 4

| | | | | | Contact | Contact | | | |
|---|---|---|---|---|---|---|---|---|---|
| | | | Inorganic | | angle | angle | | One day | |
| | | Spherical | fine | | after | after | Immediately | after | |
| | Base resin | particles | particles | Oil | coating | friction | after rubbing | rubbing | Remarks |
| Example 11 | Fluororesin | 12 μm | 4 μm | Fluorinated | 151 | 145 | No water | No water | |
| | 20% by mass | silica | PTFE | oil | degrees | degrees | adhered | adhered | |
| | | 20% by | 5% by | 3% by mass | | | | | |
| | | mass | mass | | | | | | |
| Comparative | Fluororesin | 12 μm | 4 μm | Fluorinated | 152 | 105 | Water | Water | Too large |
| Example 11 | 15% by mass | silica | PTFE | oil | degrees | degrees | droplets | droplets | amount of |
| | | 15% by | 20% by | 3% by mass | | | adhered to | adhered to | inorganic |
| | | mass | mass | | | | entire | entire | fine |
| | | | | | | | surface | surface | particles |
| Comparative | Fluororesin | 3.5 μm | 4 μm | Fluorinated | 153 | 120 | Water | Water | Too large |
| Example 12 | 20% by mass | silica | PTFE | oil | degrees | degrees | droplets | droplets | particle |
| | | 20% by | 5% by | 5% by mass | | | adhered to | adhered to | diameter of |
| | | mass | mass | | | | entire | entire | inorganic |
| | | | | | | | surface | surface | fine |
| | | | | | | | | | particles |

In Example 11, in which fluororesin particles were employed as the inorganic fine particles 7, high water repellency, wear resistance, and maintainability of water repellency after being damaged were achieved. In any of the cases of Comparative Example 11, where the amount of fluororesin particles was too large, and of Comparative Example 12, where the fluororesin particles were too large as compared to the spherical particles 5, the wear resistance was not achieved, showing that the particle diameter and the amount of the fluororesin to be added should be appropriate.

### Example 12 and Comparative Examples 13 to 15

A fluororesin (Bonnflon GT-SR, made by AGC Coat-Tech Co., Ltd.), spherical silica (average particle diameter: 3.5 μm, Denka Company Limited) treated with hexamethyldisilazane to be hydrophobic as the spherical particles 5, silica nanoparticles (X-30, average particle diameter of primary particles: 7 nm, made by Tokuyama Corporation) treated with dimethyldichlorosilane to be hydrophobic as the inorganic nanoparticles 11, water-repellent silica particles (AZ-260, 2 μm, made by Tosoh Silica Corporation) as the inorganic fine particles 7, and a silicone oil (KF-96-3,000cs, made by Shin-Etsu Silicone Co., Ltd.) as the oil 10 were employed to prepare a coating liquid containing mineral spirit as a solvent in the mixing ratios shown in Table 5. Note that the values in the column of the oil 10 denote mass ratios relative to the total amount of the fluororesin, the inorganic fine particles 7, and the inorganic nanoparticles 11. This liquid was applied onto a galvanized steel plate by spray coating and dried. Thereafter, the friction and damage tests were performed as in Example 3.

TABLE 5

| | | | | | | Contact | Contact | | | |
|---|---|---|---|---|---|---|---|---|---|---|
| | | | Inorganic | | | angle | angle | | One day | |
| | | Spherical | fine | Inorganic | | after | after | Immediately | after | |
| | Fluororesin | particles | particles | nanoparticles | Oil | coating | friction | after rubbing | rubbing | Remarks |
| Example 12 | 20% by | 15% by | 5% by | 7% by mass | 3% by | 140 | 130 | Adhered as | Adhered | |
| | mass | mass | mass | | mass | degrees | degrees | water | as water | |
| | | | | | | | | droplets | droplets | |
| Comparative | 20% by | 15% by | None | 7% by mass | 3% by | 135 | 102 | Water | Water | No |
| Example 13 | mass | mass | | | mass | degrees | degrees | adhered | adhered | inorganic |
| | | | | | | | | linearly | linearly | fine particle |
| Comparative | 20% by | 15% by | 5% by | None | 3% by | 80 | 78 | Water | Water | No |
| Example 14 | mass | mass | mass | | mass | degrees | degrees | droplets | droplets | inorganic |
| | | | | | | | | adhered to | adhered | nanoparticle |
| | | | | | | | | entire | to entire | |
| | | | | | | | | surface | surface | |
| Comparative | 20% by | 15% by | 5% by | 7% by mass | None | 143 | 130 | Water | Water | No oil |
| Example 15 | mass | mass | mass | | | degrees | degrees | adhered | adhered | |
| | | | | | | | | linearly | linearly | |

In Example 12, in which the coating was formed by single coating, high water repellency, wear resistance, and maintainability of water repellency after being damaged were achieved. The composition of Comparative Example 13 did not contain the inorganic fine particles 7, and wear resistance was not achieved. The composition of Comparative Example 14 did not contain the inorganic nanoparticles 11, and high water repellency was not achieved. The composition of Comparative Example 15 did not contain the oil 10, and the water repellency of the damaged portion decreased and was not recovered even after the lapse of time. It can be seen that water repellency, wear resistance, and maintainability of water repellency after being damaged are achieved by appropriate formulation of the respective components to be mixed.

### REFERENCE SIGNS LIST

1: substrate, 2: undercoat layer, 3: overcoat layer, 5: spherical particles, 6: base resin, 7: inorganic fine particles, 9: void, 10: oil, 11: inorganic nanoparticles, 12: water-repellent resin, 15: water-repellent resin, 100: water-repellent coating, 100a: water-repellent coating, 200: water-repellent coating, 207: inorganic fine particles, 300: water-repellent coating

1. A water-repellent coating comprising:
spherical particles;
inorganic fine particles having an average particle diameter less than an average particle diameter of the spherical particles;
inorganic nanoparticles forming fine irregularities on a surface;
a water-repellent resin having water repellency; and
an oil.

2. The water-repellent coating of claim 1, comprising:
an undercoat layer containing the spherical particles, the inorganic fine particles, the oil, the spherical particles, and a base resin; and
an overcoat layer containing the inorganic nanoparticles and the water-repellent resin, the overcoat layer being formed on the undercoat layer.

3. The water-repellent coating of claim 2, wherein
an amount of the oil is 1% or more and 30% or less by weight ratio relative to a total amount of the base resin and the inorganic fine particles.

4. The water-repellent coating of claim 2, wherein
the base resin is a polyurethane resin or a fluororesin.

5. The water-repellent coating of claim 2, wherein
the overcoat layer has a contact angle of water of 140 degrees or more.

6. The water-repellent coating of claim 1, wherein
the spherical particles have an average particle diameter of 2 μm or more and 50 μm or less, and
the spherical particles are at least one kind selected from the group consisting of spherical fused silica particles, spherical fused alumina particles, and spherical silicone resin particles.

7. The water-repellent coating of claim 1, wherein
the inorganic fine particles are porous particles having an average particle diameter of 1 μm or more and 5 μm or less.

8. The water-repellent coating of claim 1, wherein
the inorganic fine particles are fluororesin particles having an average particle diameter of 0.05 μm or more and 15 μm or less.

9. The water-repellent coating of claim 1, wherein
the inorganic nanoparticles have an average particle diameter of 2 nm or more and 20 nm or less.

10. The water-repellent coating of claim 1, wherein
the water-repellent resin is a fluororesin or a silicone resin.

11. The water-repellent coating of claim 1, wherein
an amount of the oil added is 1% by weight or more and 30% by weight or less relative to a total amount of the water-repellent resin, the inorganic nanoparticles, and the spherical particles.

12. The water-repellent coating of claim 1, wherein
the spherical particles are impregnated with the oil.

13. An article comprising:
a substrate; and
the water-repellent coating of claim 1, the water-repellent coating being formed on the substrate.

14. The article of claim 2, wherein
a medium in which the base resin is soluble is contained.

15. The article of claim 13, wherein
a medium in which the water-repellent resin is soluble is contained.
